(19) United States
(12) Patent Application Publication
(10) Pub. No.: US 2017/0278363 A1
(43) Pub. Date: Sep. 28, 2017

(54) EMERGENCY DOORBELL COMMUNICATOR

(71) Applicant: Vivint, Inc., Provo, UT (US)

(72) Inventor: Adam K. Webb, Provo, UT (US)

(21) Appl. No.: 15/078,107

(22) Filed: Mar. 23, 2016

(51) Int. Cl. G08B 13/02; G08B 21/22

(52) U.S. Cl. CPC G08B 13/02; G08B 21/22

(57) ABSTRACT

Systems, apparatuses, and methods relating to security and/or automation systems are described. In one embodiment, a method may include determining an emergency condition at a structure, detecting a user such as an emergency responder at a boundary of the structure, determining a characteristic of the user at the boundary, and communicating information to the user at the boundary based at least in part on the determined emergency condition and the determined user characteristic. In some cases, this communication may include visual or audio information relating to the emergency condition, including a type of emergency condition, a location of an injured person, or a location related to the structure or the emergency itself, among other things.

### BACKGROUND

The present disclosure, for example, relates to security and/or automation systems, and more particularly to emergency doorbell communicators.

Security and automation systems are widely deployed to provide various types of communication and functional features such as monitoring, communication, notification, and/or others. These systems may be capable of supporting communication with a user through a communication connection or a system management action.

Current security systems allow for users to enter a building that the security system protects based on manual user input. But requiring manual input by the owner may place a heavy burden on the user, as whomever the owner wishes to have access to the premises may change based on certain circumstances. For example, during an emergency situation emergency responders may attempt entry into the premises to resolve an emergency, but may be unable to do so based on security system features.

### SUMMARY

Current security systems allow for users to enter a building of which the security system is protecting by preauthorized recognition of the user. That is, an owner of the security system can manually input who can and who cannot enter the premises. Based on this input, the security system can determine who is attempting entry of the premises and either allow or block entry of the user. But requiring manual input by the owner may place a heavy burden on the user, as whomever the owner wishes to have access to the premises may change based on certain circumstances surrounding the entry attempt or based on a change in relationship with the user.

For example, during an emergency situation, emergency responders may attempt entry into the premises in order to resolve an emergency. Individuals within the premises may be incapacitated or unavailable, and unable to allow entry into the home. Additionally, there may be information about the emergency situation that may be useful to the emergency responders in resolving the emergency situation and/or aiding individuals within the home or protecting the home itself. However, current systems lack an ability to either provide real-time notifications to emergency responders or allow automatic entry to responders based on the circumstances on the premises.

A home security and automation system according to the present disclosure dynamically allows entry into a structure and/or notifies a user of emergency conditions related to the structure. The home automation system may take into account conditions within a structure, as well as characteristics of one or more users attempting to gain entry into the structure when determining whether to allow access into the structure and/or provide a notification of the emergency conditions related to the structure. This allows emergency responders ease of access into a structure where an emergency may be occurring as well as providing helpful, real-time information to the emergency responders without any required action on the part of individuals within or relating to the structure.

According to at least one embodiment, a method for home automation systems is described. In some embodiments, the method may include determining an emergency condition at a structure, detecting a user at a boundary of the structure using a first sensor, determining a characteristic relating to the user at the boundary, and/or communicating information to the user at the boundary based at least in part on the determined emergency condition and the determined characteristic.

In some embodiments, the method may include detecting an identity of the user at the boundary. In some embodiments, the method may include detecting a classification or an occupation of the user at the boundary.

In some embodiments, the method may include comparing the determined characteristic with data stored in memory, and the communicating may be based at least in part on the comparison. In other embodiments, the method may further include unlocking an entrance of the structure based at least in part on detecting the user at the boundary and the determined characteristic.

In some embodiments, the method may further include determining the characteristic based at least in part on data received from a second sensor. In some embodiments, the second sensor comprises an image sensor. In some embodiments, the method may further comprise adjusting the information to be communicated based at least in part on determining the characteristic.

In some embodiments, the method may further include determining the emergency condition based at least in part on data received from a sensor at the structure. The sensor may comprise a sensor at an entrance, a sensor within the structure, or both.

In some embodiments, the method may further include detecting an alert of emergency personnel to the structure, and the communicated information may be based at least in part on the detected alert. In other embodiments, the method may further include unlocking a second entrance of the structure based at least in part on the detected characteristic.

In some embodiments, the communicated information may comprise a notification based at least in part on the emergency condition, or a location of an entrance of the structure, or a location within the structure, or some combination thereof. In some embodiments, communicating the information may comprise communicating information at a first time at an entrance of the structure, and communicating information at a second time within the structure based at least in part on the location of the user of the location of the emergency condition. In still other embodiments, the communicated information may comprise an audible update, or a visual update, or a combination thereof. In some embodiments, the audible update may include a live communication received from a user at a remote location, the communication based at least in part on the determined emergency condition.

In some embodiments, the determined emergency condition may comprise at least one of a security event, a medical event, or an environmental event.

According to at least one embodiment, an apparatus for home automation systems is described. The apparatus may include a processor, memory in electronic communication with the processor, and instructions stored in the memory. The instructions may be operable to cause the processor to determine an emergency condition at a structure, detect a user at a boundary of the structure using a first sensor, determine a characteristic relating to the user at the boundary, and communicate information to the user at the boundary based at least in part on the determined emergency condition and the determined characteristic.

According to at least on embodiment, a non-transitory computer readable medium for home automation systems is described. The non-transitory computer-readable medium may include instructions to cause a processor to determine an emergency condition at a structure, detect a user at a boundary of the structure using a first sensor, determine a characteristic relating to the user at the boundary, and communicate information to the user at the boundary based at least in part on the determined emergency condition and the determined characteristic.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 shows a block diagram of an example of a security and/or automation system in accordance with various embodiments;

FIG. 2 shows a block diagram of a device relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram relating to a security and/or an automation system, in accordance with various aspects of this disclosure;

FIG. 5 shows a block diagram of an apparatus relating to a security and/or an automation system, in accordance with various aspects of this disclosure

FIG. 6 shows a block diagram of an apparatus relating to a security and/or an automation system, in accordance with various aspects of this disclosure;

FIG. 7 is a flow chart illustrating an example of a method relating to a security and/or an automation system, in accordance with various aspects of this disclosure; and

FIG. 8 is a flow chart illustrating an example of a method relating to a security and/or an automation system, in accordance with various aspects of this disclosure.

### DETAILED DESCRIPTION

An emergency event often triggers chaos and confusion. If the emergency is at a home, people within the home may be incapacitated or may be too emotionally distraught due to the chaotic nature of the event to react rationally or be able to help or communicate with others. Upon the arrival of emergency responders, the people within the home may not be able to communicate to emergency responders critical details related to the emergency event that will assist the emergency responders with carrying out their duties as quickly and as efficiently as possible. In other circumstances, there may not be people within the home at all during the emergency event, placing the emergency responders in the same predicament. In other situations, entryways into the home may be locked, forcing the emergency responders to forcefully open the entryway or waste precious time finding an alternative entrance into the home.

The present disclosure allows for a home automation system to dynamically allow entry into a home during an emergency and/or provide information to an individual attempting access relating to an emergency situation occurring within the home. The home automation system may determine that an emergency condition is occurring within the home, determine that a user—such as an emergency responder—is at an entryway of the home and who that user is, and allow entry (e.g., via unlocking an entryway) and/or provide information relating about the emergency to the user based on determining the emergency condition and determining that the user is authorized to enter/receive information. This way, the home automation system can identify approaching emergency responders and can assist them in carrying out their duties by quickly providing critical information related to the emergency and/or allowing easy entry into the home. If an unauthorized user is approaching the home, the home automation system may maintain the locked entryway and/or provide information to the user. The information provided to the user may differ based on determining information related to the user, such as an identity. For example, a stranger may be provided no information at all or a message stating that he/she is not permitted to enter. If a friend or family member approaches, the home automation system may notify the individual that an emergency is occurring in the home and it may be safer if the individual stays away from the premises until emergency responders arrive. These determinations of whether to allow access/provide information to the user may be done independent of a homeowner's explicit authorization (e.g., no real-time authorization or previous manual input authorization by the homeowner or the home occupant is required). In this way, the home automation system may provide valuable assistance to emergency responders in resolving the emergency without the homeowner having to actively participate in the home automation system's determinations. Additionally, the home automation system of the present disclosure allows for the maintaining of standard security measures that a homeowner expects in protecting the home from unwanted access.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

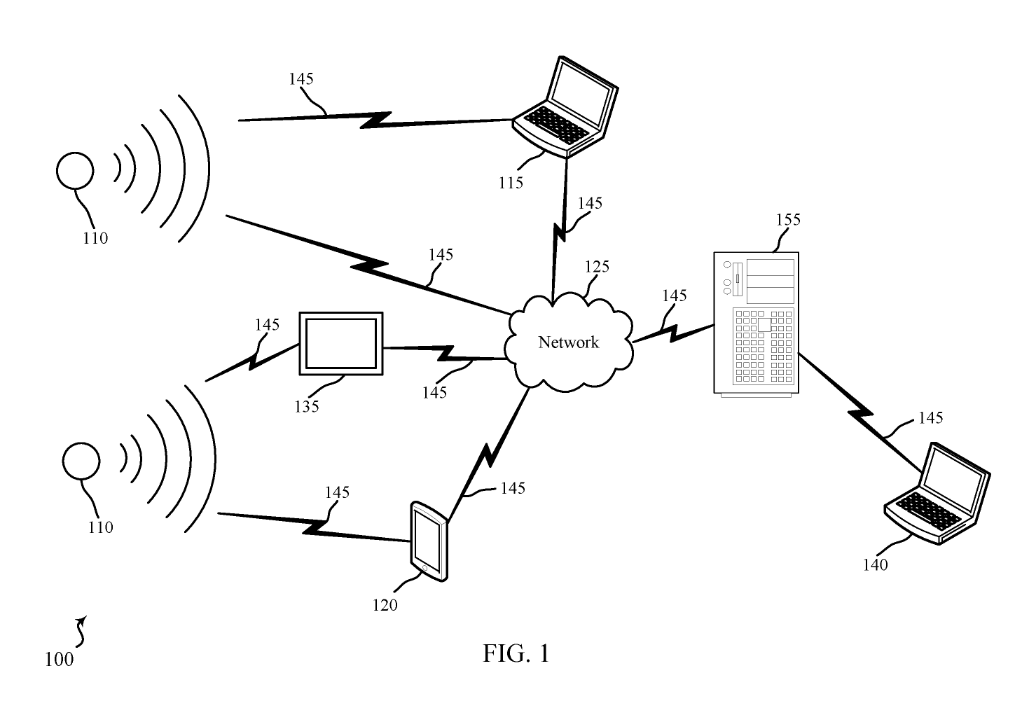

FIG. 1 is an example of a communications system 100 in accordance with various aspects of the disclosure. In some embodiments, the communications system 100 may include one or more sensors 110, local computing device 115, 120, network 125, server 155, control panel 135, and remote computing device 140. One or more sensors 110 may communicate via wired or wireless communication links 145 with one or more of the local computing device 115, 120 or network 125. The network 125 may communicate via wired or wireless communication links 145 with the control panel 135 and the remote computing device 140 via server 155. In alternate embodiments, the network 125 may be integrated with any one of the local computing device 115, 120, server 155, or remote computing device 140, such that separate components are not required.

Local computing device 115, 120 and remote computing device 140 may be custom computing entities configured to interact with sensors 110 via network 125, and in some embodiments, via server 155. In other embodiments, local computing device 115, 120 and remote computing device 140 may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a mobile phone, a personal digital assistant (PDA), and/or any other suitable device operable to send and receive signals, store and retrieve data, and/or execute modules.

Control panel 135 may be a smart home system panel, for example, an interactive panel mounted on a wall in a user's home. Control panel 135 may be in direct communication via wired or wireless communication links 145 with the one or more sensors 110, or may receive sensor data from the one or more sensors 110 via local computing devices 115, 120 and network 125, or may receive data via remote computing device 140, server 155, and network 125.

The local computing devices 115, 120 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor 110.

The processor of the local computing devices 115, 120 may be operable to control operation of the output of the local computing devices 115, 120. The output may be a television, a liquid crystal display (LCD) monitor, a cathode ray tube (CRT) monitor, speaker, tactile output device, and/or the like. In some embodiments, the output may be an integral component of the local computing devices 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 115, 120 to the output.

The remote computing device 140 may be a computing entity operable to enable a remote user to monitor the output of the sensors 110. The remote computing device 140 may be functionally and/or structurally similar to the local computing devices 115, 120 and may be operable to receive data streams from and/or send signals to at least one of the sensors 110 via the network 125. The network 125 may be the Internet, an intranet, a personal area network, a local area network (LAN), a wide area network (WAN), a virtual network, a telecommunications network implemented as a wired network and/or wireless network, etc. The remote computing device 140 may receive and/or send signals over the network 125 via communication links 145 and server 155.

In some embodiments, the one or more sensors 110 may be sensors configured to conduct periodic or ongoing automatic measurements related to emergency doorbell communications or entrance-related communications. Each sensor 110 may be capable of sensing multiple emergency parameters, or alternatively, separate sensors 110 may monitor separate emergency parameters, occupancy, parameters, location parameters, and/or other information. For example, one sensor 110 may measure gas emissions, while another sensor 110 (or, in some embodiments, the same sensor 110) may detect biometric, noise, or location-related indicators. In some embodiments, one or more sensors 110 may additionally monitor alternate structural feature parameters, such as window breaking parameters (e.g., breaking glass), temperature of a home area, temperature of a sensor, etc. Sensors 110 may also monitor a variety of user characteristic features. In alternate embodiments, a user may input user authorization data directly at the local computing device 115, 120 or at remote computing device 140. For example, a user may enter user identification data into a dedicated application on his smart phone indicating authorization to access a structure or that a certain condition exists within or related to the home, which may be associated with an emergency.

Data gathered by the one or more sensors 110 may be communicated to local computing device 115, 120, which may be, in some embodiments, a thermostat or other wall-mounted input/output smart home display. In other embodiments, local computing device 115, 120 may be a personal computer or smart phone. Where local computing device 115, 120 is a smart phone, the smart phone may have a dedicated application directed to collecting emergency condition data, and calculating and executing emergency communications therefrom. The local computing device 115, 120 may process the data received from the one or more sensors 110 to determine an emergency condition. In alternate embodiments, remote computing device 140 may process the data received from the one or more sensors 110, via network 125 and server 155, to determine emergency-related conditions and/or data based on a home or home occupants that relate to the home or a condition within the home. Data transmission may occur via, for example, frequencies appropriate for a personal area network (such as BLUETOOTH® or IR communications) or local or wide area network frequencies such as radio frequencies specified by the IEEE 802.15.4 standard.

In some embodiments, local computing device 115, 120 may communicate with remote computing device 140 or control panel 135 via network 125 and server 155. Examples of networks 125 include cloud networks, local area networks (LAN), wide area networks (WAN), virtual private networks (VPN), wireless networks (using 802.11, for example), and/or cellular networks (using 3G and/or LTE, for example), etc. In some configurations, the network 125 may include the Internet. In some embodiments, a user may access the functions of local computing device 115, 120 from remote computing device 140. For example, in some embodiments, remote computing device 140 may include a mobile application that interfaces with one or more functions of local computing device 115, 120.

The server 155 may be configured to communicate with the sensors 110, the local computing devices 115, 120, the remote computing device 140 and control panel 135. The server 155 may perform additional processing on signals received from the sensors 110 or local computing devices 115, 120, or may simply forward the received information to the remote computing device 140 and control panel 135.

Server 155 may be a computing device operable to receive data streams (e.g., from sensors 110 and/or local computing device 115, 120 or remote computing device 140), store and/or process data, and/or transmit data and/or data summaries (e.g., to remote computing device 140). For example, server 155 may receive a stream of smoke detection data from a sensor 110, a stream of heat detection data from the same or a different sensor 110, and a stream of characteristic determination data or location-related data from either the same or another sensor 110. In some embodiments, server 155 may “pull” the data streams (e.g., by querying the sensor 110, the local computing devices 115, 120, and/or the control panel 135). In some embodiments, the data streams may be “pushed” from the sensors 110 and/or the local computing devices 115, 120 to the server 155. For example, the sensors 110 and/or the local computing device 115, 120 may be configured to transmit data as it is generated by or entered into that device. In some instances, the sensors 110 and/or the local computing devices 115, 120 may periodically transmit data (e.g., as a block of data or as one or more data points).

The server 155 may include a database (e.g., in memory) containing emergency condition data received from the sensors 110 and/or the local computing devices 115, 120. Additionally, as described in further detail herein, software (e.g., stored in memory) may be executed on a processor of the server 155. Such software (executed on the processor) may be operable to cause the server 155 to monitor, process, summarize, present, and/or send a signal associated with resource usage data.

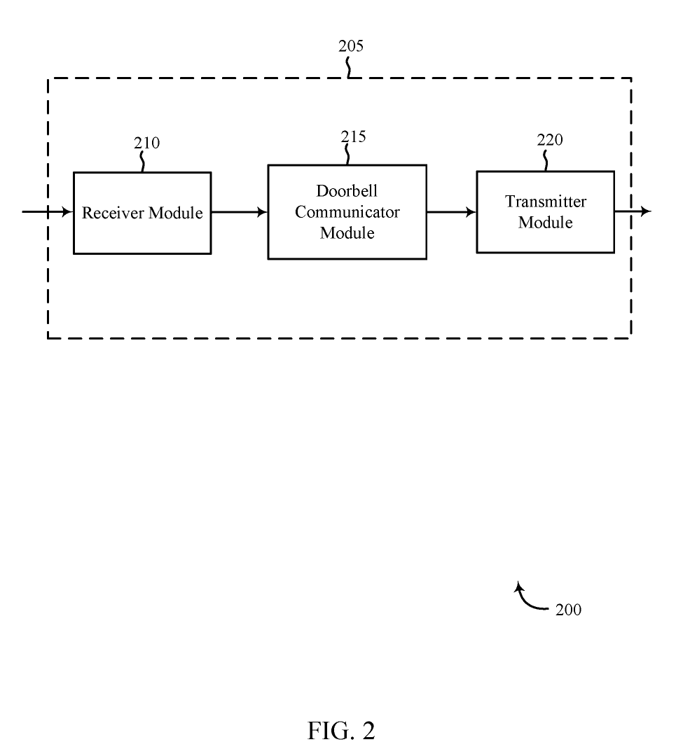

FIG. 2 shows a block diagram 200 of a control panel 205 for use in electronic communication, in accordance with various aspects of this disclosure. The control panel 205 may be an example of one or more aspects of a control panel 105, a device 115, and/or a device 120 as described with reference to FIG. 1. In some embodiments, the control panel 205 may be an example of or include a doorbell device, such as a stand-alone doorbell camera positioned at an entrance to a structure. The term control panel or control device should not otherwise be construed as limiting this disclosure. The control panel 205 may include a receiver module 210, a doorbell communicator module 215, and/or a transmitter module 220. The control panel 205 may also be or include a processor. Each of these modules may be in communication with each other—directly and/or indirectly.

The components of the control panel 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive emergency condition data, user detection data, and/or user characterization data. Information may be passed on to the doorbell communicator module 215, and to other components of the control panel 205.

The doorbell communicator module 215 may receive emergency condition data, user detection, and/or characterization data—among other types—from receiver module 210. Doorbell communicator module may then process the data and determine whether to communicate information relating to an emergency condition within a structure based on the received data. Or in some embodiments, an emergency condition may trigger an automatic notification and alarm the doorbell communicator module 215 may determine whether to initiate an automation or security system action (e.g., unlock an entryway of the structure) based on the received data from receiver module 210.

The transmitter module 220 may transmit the one or more signals received from other components of the control panel 205. The transmitter module 220 may transmit information relating to emergency condition data, user detection data, and/or user characterization data relating to a structure. In some examples, the transmitter module 220 may be collocated with the receiver module 210 in a transceiver module.

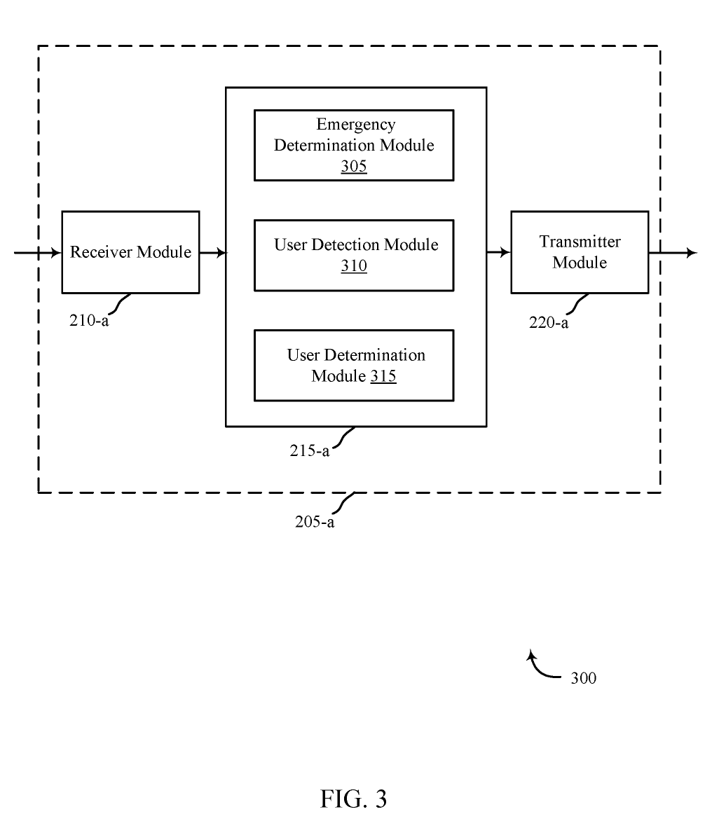

FIG. 3 shows a block diagram 300 of a control panel 205-a for use in wireless communication, in accordance with various examples. The control panel 205-a may be an example of one or more aspects of a control panel 105 described with reference to FIG. 1. It may also be an example of a control panel 205 described with reference to FIG. 2, among others. The control panel 205-a may include a receiver module 210-a, a doorbell communicator module 215-a, and/or a transmitter module 220-a, which may be examples of the corresponding modules of control panel 205. The control panel 205-a may also include a processor. Each of these components may be in communication with each other. The doorbell communicator module 215-a may include an emergency determination module 305, a user detection module 310, and a user determination module 315. The receiver module 210-a and the transmitter module 220-a may perform the functions of the receiver module 210 and the transmitter module 220, of FIG. 2, respectively.

The components of the control panel 205-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

In some embodiments, emergency determination module 305 may determine whether an emergency is occurring within a structure based on received information and/or data. Emergency determination module may receive emergency-related data from receiver module 210-a and subsequently determine whether an emergency condition exists within a structure based on a set of rules, comparisons, calculations, detections, evaluations, and/or determining steps, among other things. For example, an emergency condition may comprise a medical (e.g., heart attack, unconsciousness, fall, broken bone), security (e.g., trespassing, breaking and entering, vandalism, burglary, assault), or environmental (e.g., noxious gas, fire, flood, carbon monoxide) emergency. Additionally or alternatively, the emergency determination module 305 may determine the location of an emergency occurring within the home, which may be based on receiving sensor data from one or more locations relating to the home or other input relating to a condition or a person. Additionally, the emergency determination module 305 may determine that more than one emergency conditions are occurring within a structure. For example, emergency determination module 305 may receive data from one or more sensors indicating high noxious gas levels within the structure at one or more locations. The emergency determination module 305 may also receive data from the same sensor, or a different sensor, indicating the presence of an unconscious individual within the structure. The emergency determination module 305 may determine that a single emergency is occurring within the structure using one or more relationships, comparisons, determinations, and/or evaluations (e.g., a cause-effect relationship between the noxious gas and the unconscious individual), or alternatively, determine that multiple emergency conditions of the same or different types are occurring (e.g., the noxious gas condition did not cause the individual to fall unconscious). Additionally or alternatively, emergency determination module may determine ancillary conditions related to the emergency including those relating to one or more individuals, locations, system components, or other information (e.g., what entryways are open for access, what authorized people are currently within the structure).

User detection module 310 may detect a user (e.g., a person capable of providing aid, an emergency responder, a friend or a neighbor) approaching the structure. User detection module may detect a user's position and location via a sensor 110, where the sensor 110 may be a motion sensor, a proximity sensor, an image sensor, some combination, or another sensor. Additionally, user detection module 310 may detect a user by a combination of sensors 110, such as video sensors, motion detectors, heat detectors, or the like.

User determination module 315 may determine the identity of the user. User determination module 315 may determine the identity of the user by determining one or more characteristics of the user. Additionally or alternatively, the user determination module may determine a classification or occupation of the user based on certain data, actions, identifications, characterizations, comparisons, analyses, or other actions. Additionally or alternatively, the determined characteristic of the user may be compared to data stored in memory, where the stored data may be inputted by a system owner or a third party vendor.

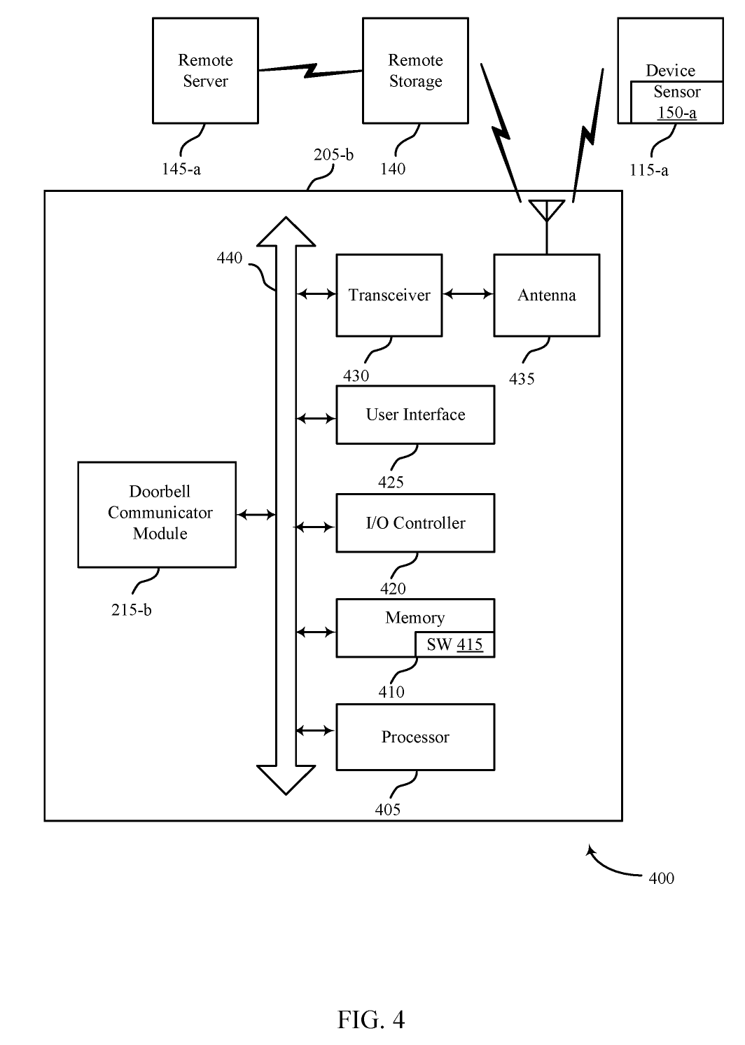

FIG. 4 shows a system 400 for use in emergency doorbell communication systems, in accordance with various examples. System 400 may include a control panel 205-b, which may be an example of the control panels 105 of FIG. 1. Control panel 205-b may also be an example of one or more aspects of control panels 205 and/or 205-a of FIGS. 2 and 3.

Control panel 205-b may also include components for bi-directional voice and data communications including components for transmitting communications and components for receiving communications. For example, control panel 205-b may communicate bi-directionally with one or more of device 115-a, one or more sensors 150-a, remote storage 140, and/or remote server 145-a, which may be an example of the remote computing device of FIG. 1. This bi-directional communication may be direct (e.g., control panel 205-b communicating directly with remote storage 140) or indirect (e.g., control panel 205-b communicating indirectly with remote server 145-a through remote storage 140).

Control panel 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 140, and/or remote server 145-a. The transceiver module 430 may include a modem to modulate the packets and provide the modulated packets to the one or more antennas 435 for transmission, and to demodulate packets received from the one or more antenna 435. While a control panel or a control device (e.g., 205-b) may include a single antenna 435, the control panel or the control device may also have multiple antennas 435 capable of concurrently transmitting or receiving multiple wired and/or wireless transmissions. In some embodiments, one element of control panel 205-b (e.g., one or more antennas 435, transceiver module 430, etc.) may provide a direct connection to a remote server 145-a via a direct network link to the Internet via a POP (point of presence). In some embodiments, one element of control panel 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself.

In some embodiments, one or more sensors 150-a (e.g., motion, proximity, smoke, light, glass break, door, window, carbon monoxide, and/or another sensor) may connect to some element of system 400 via a network using one or more wired and/or wireless connections.

In some embodiments, the user interface module 425 may include an audio device, such as an external speaker system (e.g., a speaker is part of doorbell device and may be used to communicate information to a user approaching or at a structure), an external display device such as a display screen, and/or an input device (e.g., remote control device interfaced with the user interface module 425 directly and/or through I/O controller module 420). Additionally or alternatively, the audio device of user interface module 425 may include speakers and/or input devices within and outside the structure. Speakers within the structure may be used to communicate information from user interface module 425 to any individual within the structure (e.g., notifying a homeowner in need of assistance that emergency responders have been contacted), while input devices within the home may be used by individuals within the structure to relay information to user interface module 425 audibly or by physical input (e.g., homeowner needs medical assistance and commands system 400 to contact paramedics, guiding a person at a first location to a second location).

One or more buses 440 may allow data communication between one or more elements of control panel 205-b (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., determining an emergency condition at a property, detecting a user at a property, determining the identity of the user at the property, and communicating information to the user regarding the emergency condition based on the user detection and user identity determination).

Additionally, processor module 405 may also unlock an entryway for ease of access for a user, or adjust the communicated information based at least in part on the determined characteristic, among other functions. Alternatively, the software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein. The processor module 405 may include an intelligent hardware device, e.g., a central processing unit (CPU), a microcontroller, an application-specific integrated circuit (ASIC), etc.

In some embodiments, the memory 410 can contain, among other things, the Basic Input-Output system (BIOS) which may control basic hardware and/or software operation such as the interaction with peripheral components or devices. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the control panel or control device (e.g., 205-b) may include a single antenna 435, the control panel or control device (e.g., 205-b) may have multiple antennas 435 capable of concurrently transmitting and/or receiving multiple wireless transmissions.

The control panel 205-b may include a doorbell communicator module 215-b, which may perform the functions described above for the doorbell communicator modules 215 of control panel 205 of FIGS. 2 and 3.

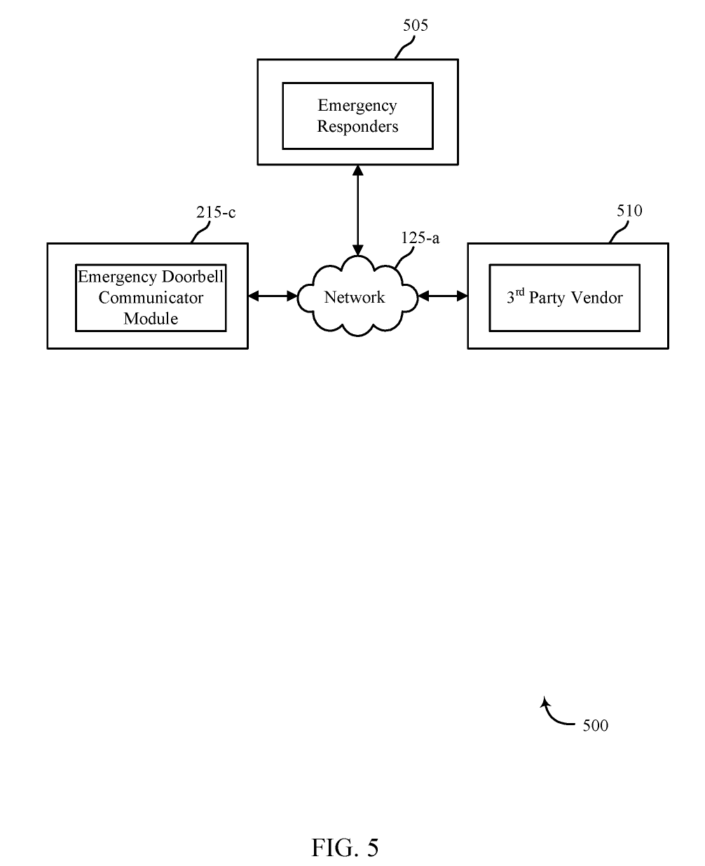

FIG. 5 illustrates an example of communications system 500 in accordance with various aspects of the present disclosure. Doorbell communicator module 215-c may be linked, via a network 125-a, to emergency responders 505 and third party vendors 510. Network 125-a may be an example of network 125 in FIG. 1, and may include a wireless network. Doorbell communicator module 215-c, after determining an emergency condition exists (or receiving a determination that an emergency condition exists), may communicate directly with emergency responders regarding the emergency condition. For example, doorbell communicator module 215-c may either notify emergency responders 505 of the emergency condition, or, may provide updated information relating to the emergency if the condition changes.

Alternatively, doorbell communicator module 215-c may detect a dispatch from emergency responders 505 to emergency doorbell communicator module's 215-c location via network 125-a, and may subsequently determine to communicate information to a detected user based at least in part on this detected dispatch. In some examples, the communication may be designed to provide information when an emergency responder (or another individual) is present outside a home, such as being at a door or a window.

In this way, doorbell communicator module 215-c may determine to communicate information regarding conditions within a structure and/or permit entry into the structure to an approaching user even without the system itself detecting the emergency condition. Alternatively, doorbell communicator module 215-c may take the dispatch information into account when determining that an emergency condition is occurring within the structure and/or when communicating to a user at an entrance to a structure and/or within a structure.

Additionally, information related to the dispatch may be utilized by doorbell communicator module 215-c. For example, the dispatch may indicate an estimated time of arrival. Doorbell communicator module 215-c may use the estimated time of arrival—among other information—in its determination to communicate information to a user.

Furthermore, in some embodiments, a person (e.g., a third party vendor, a home occupant, or another) may be able to communicate with emergency responders 505 via network 125-a in real-time when the emergency responder is outside and/or inside the home (e.g., helping troubleshooting problems with doorbell communicator module 215-c, providing instructions, describing the received data, describing received communications from an injured home occupant, providing clarification or direction).

Moreover, a third party vendor may be able to directly communicate with doorbell communicator module 215-c (e.g., troubleshooting problems, manual system override, etc.) or use doorbell communicator module 215-c to communicate directly with detected users at the location of the emergency communicator module 215-c.

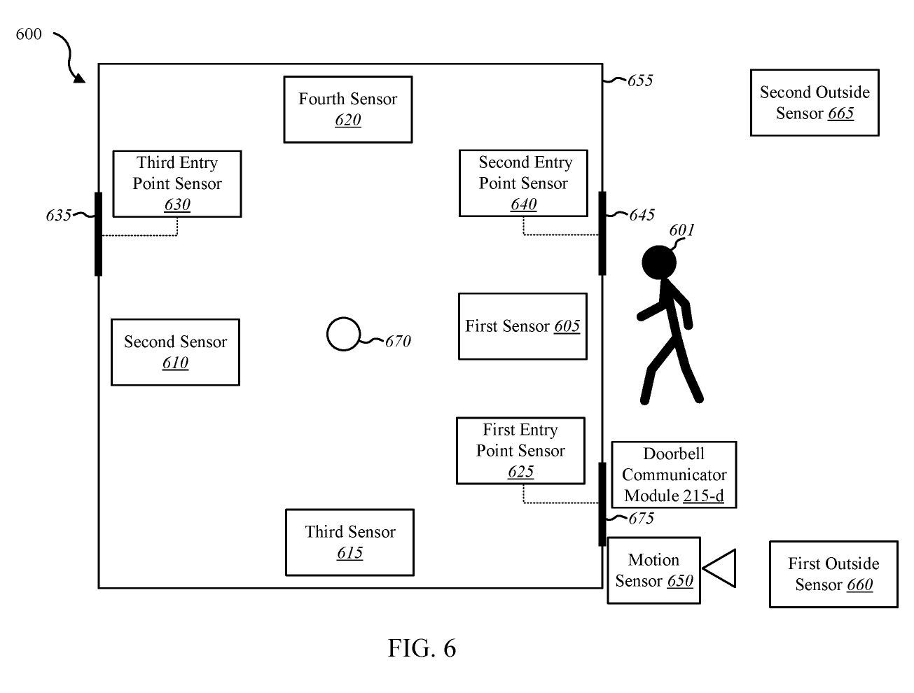

FIG. 6 illustrates an example of a home automation system 600 in accordance with various aspects of the present disclosure. The system 600 may be related to a structure 655 that may include first sensor 605, second sensor 610, third sensor 615, fourth sensor 620, first entry point sensor 625, third entry point sensor 630, second entry point sensor 640, motion sensor 650, first outside sensor 660, second outside sensor 665, second entryway 640, third entry point sensor 630, and/or doorbell communicator module 215-d.

In some embodiments, first sensor 605, second sensor 610, third sensor 615, and fourth sensor 620 may be sensors that are located within structure 655 and may be able to detect and/or capture data relating to any one of a motion, proximity, temperature, humidity, sound level, smoke, gas detection, time, geo-location data of a user and/or a device, distance, biometrics, weight, speed, height, size, preferences, light, darkness, weather, time, system performance, and/or other inputs that relate to a security and/or an automation system.

These sensors may be used to determine emergency conditions within the structure 655. The sensors may collect data according to the classification of each sensor. For example, if a sensor is a heat sensor, the sensor then collects temperature data correlated with time and date data, among other things. Data from the sensors may be collected and subsequently analyzed by system 600. For example, system 600 may have emergency condition thresholds, where, if collected data exceeds a given threshold, then system 600 may determine that an emergency condition exists.

Additionally or alternatively, data collected from more than one sensors may be correlated to determine a relationship between the different types of data. System 600 may evaluate the different type of data, along with the correlation to make a determination of whether an emergency condition exists (e.g., image data show an individual falling and sound data indicating that a person is calling for help or that a user did not make a sound after the fall indicating a loss of consciousness). This determination may be based on one of the sensors within the structure 655, or with several of the sensors within the structure 655 working in conjunction with one another and/or may be based on a device (e.g., control panel 205) that receives the data from one or more sensors, processes it, and then initiates an action.

As one non-limiting example, reference point 670 may be the location of which an emergency is occurring. First sensor 605 may determine that an emergency is occurring at reference point A 670 independent of the rest of the sensors within the structure 655 (e.g., a person falling or tripping). Alternatively, first sensor 605 may sense a condition at reference point A 670 that, when taken alone, may not determine an emergency condition. Second sensor 610 may also determine a condition at reference point A 670 (e.g., a person's audible response), where, when used in conjunction with the condition sensed at first sensor 605, system 600 may be able to determine an emergency condition is occurring at reference point A 670. The conditions sensed by first sensor 605 and second sensor 610 may be different or they may be similar types of conditions (e.g., smoke detected by first sensor 605 and high temperature detected by second sensor 610).

Additionally, first entry point sensor 625 may monitor the status of entryway 675. Additionally, entryways 635, 645, and 675 may be any type of entryway that is a feature of structure 655. For example, entryway 675 may be a door, second entryway 635 may be a door, and third entryway 645 may be a window. Entry point sensors 625, 630, and 640 may monitor the status of entryways 675, 635, and 645, respectively, and may be any type of sensors that monitor entryways, such as structural features (e.g., glass breaking, window position, door position), motion, and sound level.

For example, second entry point sensor 640 may detect that entryway 645 has been tampered with. System 600 may use this determination of tampering to determine that an emergency is occurring at entryway 645. Alternatively, this detection may be used in conjunction with other detections by other entry point sensors 625 and 630 or with detections from sensors 605-620 within the structure 655 to determine that an emergency is occurring within the structure 655 (e.g., third sensor detects a presence within the structure 655 after second entry point sensor 640 detected that second entryway was tampered with).

Motion sensor 650 may detect user 601 approaching the structure 655. First outside sensor 660 and second outside sensor 665 may sense conditions occurring outside of the structure 655 and may be examples of sensors 605-620. Alternatively, first outside sensor 660, second outside sensor 665, or both, may be video sensors where, when motion sensor 650 detects user 601, are activated and subsequently begin recording. These recordings may be stored by system 600 and/or transmitted to a third party.

Once user 601 is detected, doorbell communicator module 215-d may determine a characteristic of user 601. The characteristic may be determined by doorbell communicator module 215-d. Additionally, doorbell communicator module 215-d may determine the characteristic by utilizing video taken from first outside sensor 660 and/or second outside sensor 665. Additionally, the characteristic may comprise an identity of the user 601. Additionally or alternatively, the characteristic may comprise a classification or an occupation of the user 601.

The characteristic may be determined either dynamically (e.g., frequency of recognition by system 600 of the individual's facial/physical/audible distinctions) or manually (e.g., a user inputs authorized individuals, where individuals may be authorized according to different security levels, or based on an image or defining information related to one or more sets of expected individuals). In the case of determining information (e.g., an occupation or classification), doorbell communicator module 215-d may detect a logo on the user 601 or distinct clothing worn related to an occupation or classification (e.g., a badge, a certain hat, a coat, or some combination). Additionally, the determination may also be based on audible input by the user 601 (e.g., detecting a delivery business logo and the user 601 states that he/she is delivering a package.)

Doorbell communicator module 215-d may then communicate information to user 601 regarding the detected emergency condition within structure 655. This information may include information related to the type of emergency condition (e.g., medical, environmental, or security), the location of the emergency condition (e.g., reference point A 670), and an optimal entryway to utilize (e.g., entryway 635). Additionally, the information communicated may be dependent on the determined characteristic of the user 601.

For example, if the user 601 is determined to be a police officer and the emergency condition is determined to be a security condition, system may unlock an entryway and provide information to the user 601 of the emergency condition. However, if the user 601 is determined to be a firefighter, system 600 may keep the entryways locked and provide information to the user 601 that it user 601 should stay away from structure 655 until police arrive because of a potential threat to the user and/or others.

Additionally, system 600 may unlock an entryway for ease of access into structure 655. For example, system 600 may unlock entryway 635 after determining that entering structure 655 through entryway 635 may be the easiest pathway for emergency responders to get to the emergency condition. In another example, system 600 may determine that entryway may be the best location for quick access for user 601 to enter is entryway 675 but, due to the nature of the emergency condition, entryway 645 may be the safest place of entry for user 601. System 600 may subsequently unlock entryway 645 and provide notification of the unlocking, and circumstances surrounding the unlocking (location of entryway 645, reasons for unlocking entryway 645, and not unlocking entryway 675) via doorbell communicator module 215-d. In some cases, this unlocking can be performed with or without user verification.

Additionally or alternatively, system 600 may guide a user to different points in the structure 655. System 600 may utilize different sensors to assist user 601 in arriving at a specific location, where an emergency exists or to help provide aid for the emergency (e.g., a location of an emergency shut off, ventilation devices, injured person, designated first aid supplies).

For example, after communicating information and/or allowing access into structure 655 (e.g., via entryway 675), doorbell communicator module 215-d may also communicate the location of an emergency condition (e.g., reference point A 670). Once user 601 enters structure 655, first sensor 605 may detect the presence and location of user 601. Based on this detection, system 600 may utilize third sensor 615 to provide further communications to user 601 regarding the emergency condition based on an absolute and/or a relative location (e.g., communicating a pathway from user's 601 location to emergency condition, step-by-step directions, a summary of directions to an individual or a location within the structure, communicating updated status of emergency condition, or some combination).

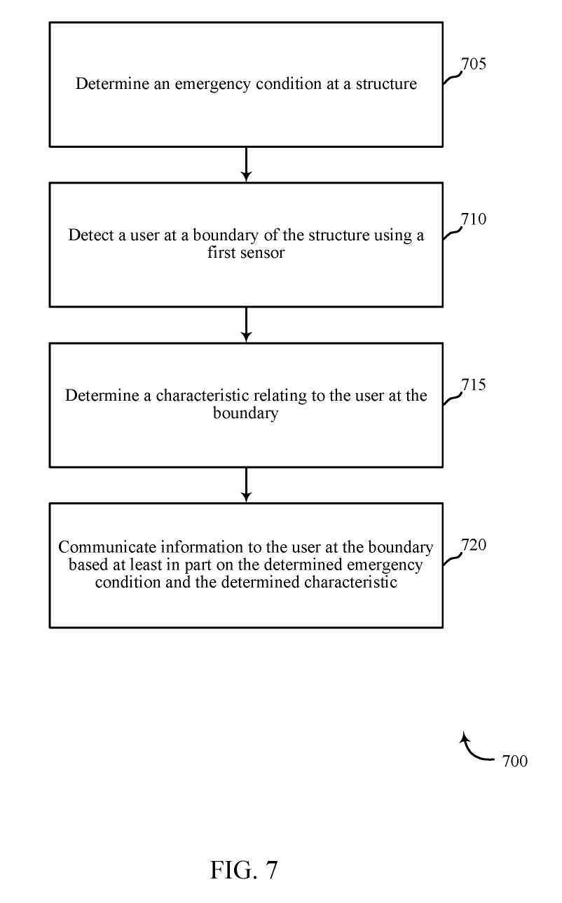

FIG. 7 is a flow chart illustrating an example of a method 700 for emergency doorbell communications in accordance with various aspects of the present disclosure. For clarity, the method 700 is described below with reference to aspects of one or more of the systems described with reference to FIGS. 1 and 4-6, and/or aspects of one or more of the block diagrams described with reference to FIGS. 2 and 3. In some examples, a control panel may execute one or more sets of codes to control the functional elements of the control panel to perform the functions described below. Additionally or alternatively, the control panel may perform one or more of the functions described below using special-purpose hardware.

At block 705, the method 700 may include determining an emergency condition at a structure. At block 710, the method 700 may include detecting a user at a boundary of the structure using a first sensor. At block 715, the method 700 may include determining a characteristic relating to the user at the boundary. At block 720, the method may include communicating information to the user at the boundary of the property based at least in part on the determined emergency condition and the determined characteristic.

The operations at blocks 705-720 may be performed using the doorbell communicator module 215 described with reference to FIGS. 2-6, among other modules and/or devices.

Thus, the method 700 may provide for emergency doorbell communications relating to automation/security systems. It should be noted that the method 700 is just one implementation and that the operations of the method 700 may be rearranged or otherwise modified such that other implementations are possible.

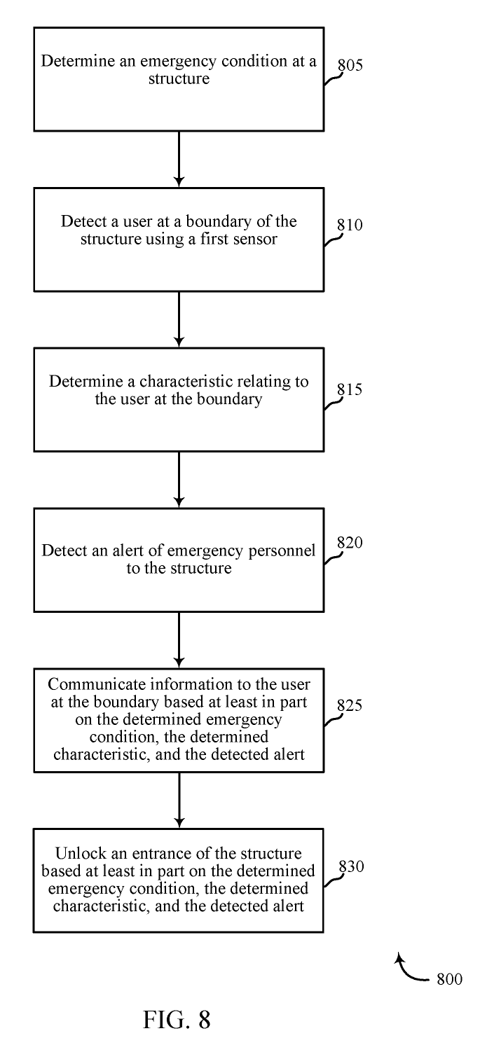

FIG. 8 is a flow chart illustrating an example of a method 800 for emergency doorbell communications in accordance with various aspects of the present disclosure. For clarity, the method 800 is described below with reference to aspects of one or more of the systems described with reference to FIGS. 1 and 4-6, and/or aspects of one or more of the block diagrams described with reference to FIGS. 2 and 3. In some examples, a control panel may execute one or more sets of codes to control the functional elements of the control panel to perform the functions described below. Additionally or alternatively, the control panel may perform one or more of the functions described below using special-purpose hardware.

At block 805, the method 800 may include determining an emergency condition at a structure. At block 810, the method 800 may include detecting a user at a boundary of the structure using a first sensor. At block 815, the method 800 may include determining a characteristic relating to the user at the boundary. At block 820, the method 800 may include detecting an alert of emergency personnel to the structure. At block 825, the method 800 may include communicating information to the user at the boundary of the property based at least in part on the determined emergency condition, the determined characteristic, and/or the detected alert. At block 830, the method 800 may include unlocking an entrance of the structure based at least in part on the determined emergency condition, the determined characteristic, and/or the detected alert.

The operations at blocks 805-830 may be performed using the doorbell communicator module 215 described with reference to FIGS. 2-6.

Thus, the method 800 may provide for emergency doorbell communications relating to automation/security systems. It should be noted that the method 800 is just one implementation and that the operations of the method 800 may be rearranged or otherwise modified such that other implementations are possible.

In some examples, aspects from two or more of the methods 700 and 800 may be combined and/or separated. It should be noted that the methods 700 and 800 are just example implementations, and that the operations of the methods 700 and 800 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

1. A method for communication by a home automation system, comprising:
determining an emergency condition at a structure;
communicating information to an emergency personnel based at least in part on the determined emergency condition;
detecting a user at a boundary of the structure using a first sensor;
determining a characteristic relating to the user at the boundary;
identifying that the user at the boundary is associated with the emergency personnel based at least in part on the determined characteristic; and
communicating updated information to the user at the boundary based at least in part on the determined emergency condition and the identifying.

2. The method of claim 1, wherein the characteristic comprises:
an identity of the user.

3. The method of claim 1, wherein the characteristic comprises:
a classification of the user or an occupation of the user.

4. The method of claim 1, further comprising:
comparing the determined characteristic with data stored in memory, wherein the communicating is based at least in part on the comparison.

5. The method of claim 1, further comprising:
unlocking an entrance of the structure based at least in part on detecting the user at the boundary and the determined characteristic.

6. The method of claim 1, wherein determining the characteristic is based at least in part on data received from a second sensor.

7. The method of claim 6, wherein the second sensor comprises:
an image sensor.

8. The method of claim 6, further comprising:
adjusting the information to be communicated based at least in part on determining the characteristic.

9. The method of claim 1, wherein the determining the emergency condition is based at least in part on data received from a sensor at the structure.

10. The method of claim 9, wherein the sensor comprises:
a sensor at an entrance, a sensor within the structure, or both.

11. The method of claim 1, further comprising:
detecting an alert of the emergency personnel to the structure, wherein the communicated updated information is based at least in part on the detected alert.

12. The method of claim 1, further comprising:
unlocking a second entrance of the structure based at least in part on the detected characteristic.

13. The method of claim 1, wherein the communicated information comprises:
a notification based at least in part on the emergency condition, or a location of an entrance of the structure, or a location within the structure, or a combination thereof.

14. The method of claim 1, wherein communicating updated information comprises:
communicating information at a first time at an entrance of the structure, and communicating information at a second time within the structure based at least in part on a location of the user or a location of the emergency condition.

15. The method of claim 1, wherein the communicated information comprises:
an audible update, or a visual update, or a combination thereof.

16. The method of claim 15, wherein the audible update comprises:
a live communication received from a user at a remote location based at least in part on the determined emergency condition.

17. The method of claim 1, wherein the determined emergency condition comprises at least one of a security event, a medical event, or an environmental event.

18. The method of claim 1, further comprising:
linking the home automation system to a third party; and
transmitting a communication between the user and the third party via the linking.

19. An apparatus for security and/or automation systems, comprising:
a processor;
memory in electronic communication with the processor; and
instructions stored in the memory, the instructions being executable by the processor to:
determine an emergency condition at a structure;
communicate information to an emergency personnel based at least in part on the determined emergency condition;
detect a user at a boundary of the structure using a first sensor;
determine a characteristic relating to the user at the boundary;
identify that the user at the boundary is associated with the emergency personnel based at least in part on the determined characteristic; and
communicate updated information to the user at the boundary based at least in part on the determined emergency condition and the identifying.

20. A non-transitory computer-readable medium storing computer-executable code, the code executable by a processor to:
determine an emergency condition at a structure;
communicate information to an emergency personnel based at least in part on the determined emergency condition;
detect a user at a boundary of the structure using a first sensor;
determine a characteristic relating to the user at the boundary;
identify that the user at the boundary is associated with the emergency personnel based at least in part on the determined characteristic; and
communicate updated information to the user at the boundary based at least in part on the determined emergency condition and the identifying.
